(19) United States
(12) Patent Application Publication
(10) Pub. No.: US 2004/0089675 A1
(43) Pub. Date: May 13, 2004

(54) Dispensing apparatus

(76) Inventors: James E. Swope, Fort Wayne, IN (US); Charles L. Karnolt, Goshen, CT (US)

Correspondence Address: Barnes & Thornburg, 600 One Summit Square, Fort Wayne, IN, 46802, US

(21) Appl. No.: 10/659,649

(22) Filed: Sep. 10, 2003

Related U.S. Application Data
(60) Provisional application No. 60/409,552, filed on Sep. 10, 2002.

(51) Int. Cl. B67D 3/00

(52) U.S. Cl. 222/529

(57) ABSTRACT

A fluid dispensing apparatus has a reservoir, a conduit connected to an outlet of the reservoir and a valve assembly connected to the conduit. The valve assembly includes a valve body, a valve element (such as a valve stem), and an actuator. The valve body has an inlet and an outlet, and a fluid flow path extending from the inlet to the outlet through the body. The valve element has a first portion fixedly retained relative to the body, and a second movably retained portion. The actuator is coupled to the movable second portion for transmitting an applied force to the valve element to cause the second portion of the valve element to move relative to the valve body to selectively block and unblock the fluid flow path. In certain embodiments, the valve body and valve element are each made as one piece structures.

### RELATED APPLICATIONS

The present application is related to and claims priority to U.S. Provisional Patent Application Serial No. 60/409,552, filed on Sep. 10, 2002, entitled “Dispensing Apparatus.” The subject matter disclosed in this application is hereby expressly incorporated into the present application.

### FIELD OF THE INVENTION

The present invention relates generally to dispensing apparatus. More particularly, the present invention relates to dispensers for fluids of various types, including cyanoacrylate adhesive.

### BACKGROUND AND SUMMARY OF THE INVENTION

In the dispensing of different types of fluids, such as certain adhesives, a relatively small, yet precisely-placed application is desirable. Many such instances call for manual application of the subject fluid. Thus, an ergonomically-suited dispensing apparatus is preferred.

It is also desirable to provide a dispensing apparatus suitable for manual applications which is reliable, easy to operate, and inexpensive to manufacture. Providing such an apparatus having a relatively small number of parts is desirable in this regard.

The above goals are achieved in a fluid dispensing apparatus which comprises a reservoir containing a quantity of fluid, a conduit connected to an outlet of the reservoir, and a valve assembly connected to the conduit. The valve assembly comprises a valve body having an inlet and outlet. A fluid flow path extends through the valve body from the inlet to the outlet. A valve element, such as a valve stem, has a first portion fixedly retained relative to the valve body, and a second portion movably retained relative to the body. The second portion acts to selectively block and unblock the fluid flow path. The valve assembly further includes an actuator which is coupled to the second portion of the valve element. The actuator transmits an applied force to the valve element to cause the second portion of the valve element to move relative to the valve body.

In certain embodiments, the valve body is spherically shaped. Specifically, the valve body may have a generally-circular cross section or, alternatively, a generally oval-shaped cross section. In these embodiments, the shape of the valve body is intended to be ergonomically compatible with the human hand.

In certain embodiments, the valve body has a surface formed internally (such as, by forming a bore having a bottom surface in the body). Such embodiments may further comprise a first bore extending from the inlet to the internally-formed surface, and a second bore extending from the outlet to the surface. The second, movable portion of the valve element is disposed adjacent the internal surface so as to selectively block and unblock at least one of the bores. In one embodiment, the valve element includes a projection which extends into one of the bores so as to block the fluid flow path when the valve element is in a first position. The projection is withdrawn from the bore when the valve element is moved to a second position so as to unblock the flow path. In certain particular embodiments, the projection extends from an approximate center of the second portion of the valve element, and at least one of the bores extends into an approximate center of the internally-formed surface.

In certain embodiments of the subject apparatus, the valve body is formed from a single piece of material. In one such embodiment, the valve body is formed of a plastic, such as DELRIN™.

The dispensing apparatus may further comprise a nozzle coupled to the outlet of the valve body. A plurality of interchangeable nozzles of varying sizes may be provided to further regulate fluid flow through the outlet.

In certain embodiments, the dispensing apparatus may comprise a retainer coupled to the valve body for retaining the valve element in position relative to the body. The retainer may comprise a surface which fixes the first portion of the valve element relative to the valve body. The valve body may be provided with a threaded bore, and the retainer may be secured to the body by means of threads which mate with the threads in the bore.

Certain embodiments further comprise a spring disposed around the second portion of the valve element to bias the second portion toward a position which blocks the fluid flow path. Such embodiments may further comprise a retainer coupled to the valve body for retaining the spring in position around the second portion of the valve element.

In some embodiments, the valve element comprises a disk-like portion having a groove formed in a surface thereof. The groove forms an area of reduced thickness in the disk-like portion. The first fixedly-retained portion of the valve element comprises an annular portion defined, at least in part, by the groove. The area of reduced thickness facilitates movement of the second movable portion of the valve element. The valve element may further comprise an elongate portion extending outwardly from the disk-like portion.

In certain embodiments, the valve element is formed from a single piece of abrasion resistant material, such as Teflon®. These or other embodiments may include a stop to limit movement of the second portion of the valve element. In one embodiment, the stop is formed as a “shoulder” or surface along the second or elongate portion thereof.

In certain embodiments, the actuator is a lever pivotally coupled to the valve element. The lever may include a camming surface to serve as a fulcrum for transmitting the applied force to the valve element. These embodiments may further comprise a retainer coupled to the valve body for retaining the valve element in position relative to the valve body. In some embodiments, the camming surface of the lever interacts with a surface of the retainer to cause the second portion of the valve element to move relative to the valve body. The lever may further be provided with at least one opening formed therein to provide a convenient mechanism for hanging or suspending the valve assembly when not is use.

Certain embodiments of the dispensing apparatus may further comprise one or more seals, including a seal disposed between the first portion of the valve element and the valve body.

Additional embodiments, features and advantages will become apparent to those skilled in the art upon consideration of the following description of the illustrated embodiments exemplifying the best mode of carrying out the invention.

### BRIEF DESCRIPTION OF DRAWINGS

Several embodiments of the present invention are shown in detail in connection with the following drawings, in which:

FIG. 1 shows a perspective view of one embodiment of an apparatus constructed in accordance with the present invention.

FIG. 2 shows a close up view of a portion of the apparatus shown in FIG. 1.

FIG. 3 shows a plan view of a manually-operated valve assembly of the type shown in FIGS. 1 and 2.

FIG. 4 shows a cross-sectional view of the valve assembly of FIG. 3 taken along line 4-4 of FIG. 3.

FIG. 5 shows a perspective view of a valve body.

FIG. 6 shows a cross-sectional view of the valve body of FIG. 5.

FIG. 7 shows a perspective view of a valve stem.

FIG. 8 shows a top plan view of the valve stem of FIG. 7.

FIG. 9 shows a side plan view of the valve stem of FIGS. 7 and 8.

FIG. 10 shows a cross-sectional view taken along line 10-10 of FIG. 9.

FIG. 11 shows a partial cross-sectional view taken along line 11-11 of FIG. 8.

FIG. 12 shows a perspective view of a collar.

FIG. 13 shows a perspective view of a lever.

FIG. 14 shows a perspective view of a retainer.

FIG. 15 shows a cross-sectional view of the retainer of FIG. 14.

FIG. 16 shows a cross sectional view of an alternative embodiment of a valve assembly.

FIG. 17 shows a cross-sectional view of a valve stem from the valve assembly of FIG. 16.

FIG. 18 shows a perspective view of a lever from the valve assembly of FIG. 16.

FIG. 19 shows a perspective view of a retainer from the valve assembly of FIG. 16.

FIG. 20 shows a cross-sectional view of the retainer of FIG. 19.

FIG. 21 shows a plan view of a seal from the valve assembly of FIG. 16.

FIG. 22 shows a partial cross section of the seal of FIG. 21 taken along line 22-22 of FIG. 21.

### DETAILED DESCRIPTION OF THE DRAWINGS

The present invention relates to a dispensing apparatus for dispensing relatively small quantities of fluids. The embodiments illustrated in the various figures and described below are particularly well suited for dispensing cyanoacrylate adhesive. As will be apparent to those of ordinary skill in the art, other fluids may also be dispensed by this or a similar apparatus. The scope of the present invention is not limited to use with cyanoacrylate adhesive.

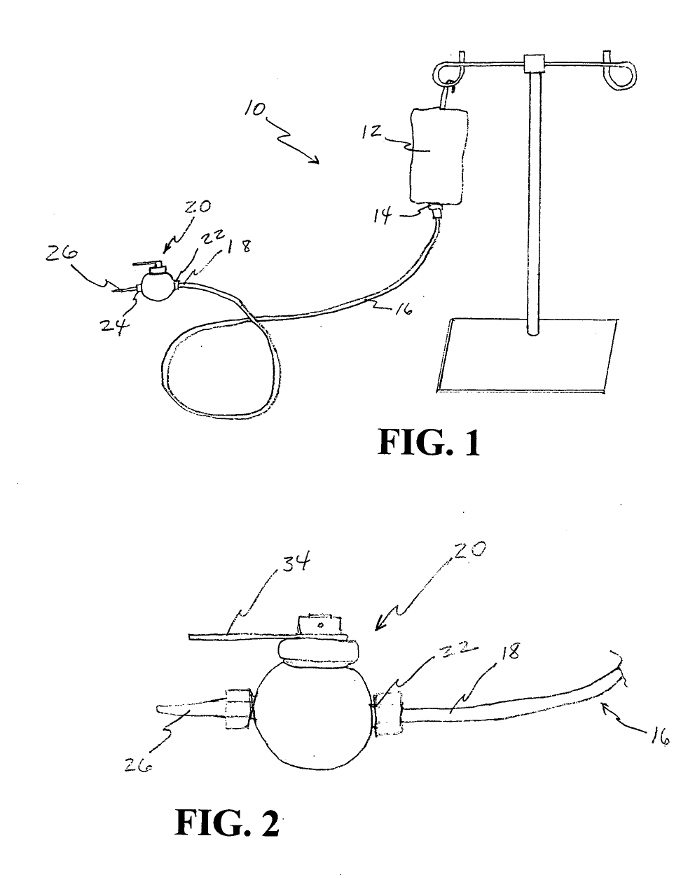

Depicted in FIG. 1 is apparatus 10 which includes a reservoir 12 having an outlet 14. In the embodiment illustrated in FIG. 1, the reservoir is a flexible, multi-layered laminated structure. The structure may include an inner layer comprising an inert olefinic material (such as polyethylene); a middle layer comprising a metallic foil (such as aluminum foil) to serve as a moisture barrier; and an abrasion resistant outer layer (such as polyester). Outlet 14 is formed on one end of reservoir 12. Reservoir 12 is suspended, as illustrated in FIG. 1, and the contents are moved through the outlet by the force of gravity.

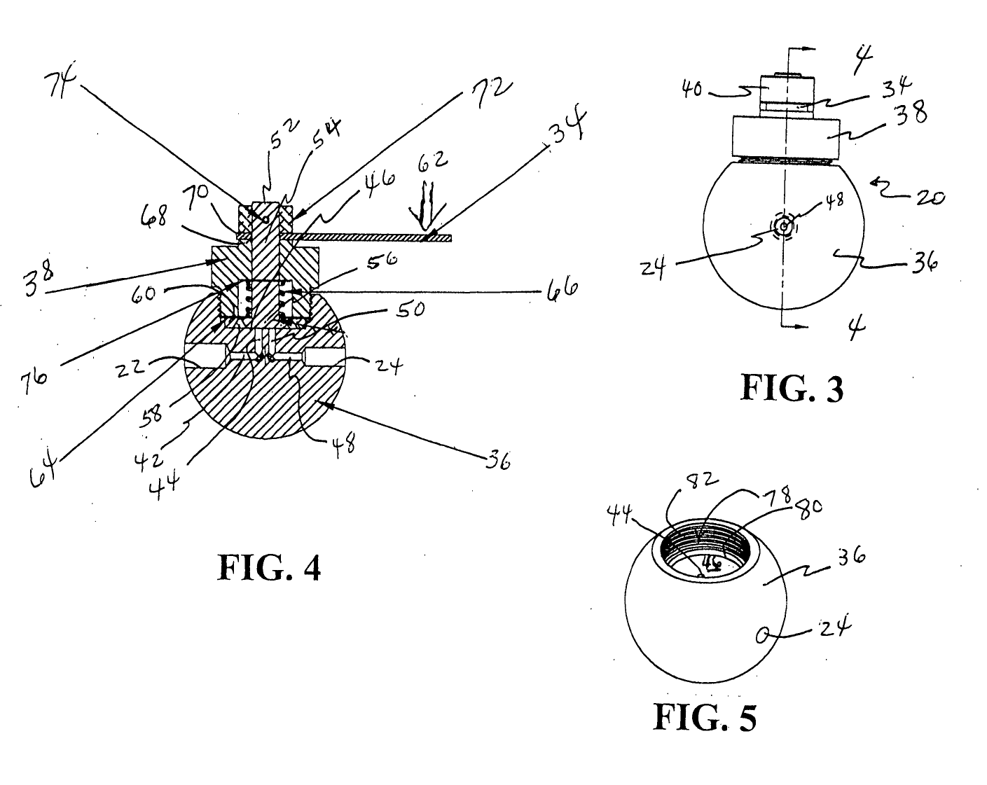

Attached to outlet 14 is a conduit 16. In the embodiment illustrated, conduit 16 is formed of plastic tubing. A distal end 18 of conduit 16 is attached to a valve assembly 20. Valve assembly 20 is discussed and described in additional detail in connection with FIGS. 3-15. Distal end 18 of conduit 16 is fluidly connected to valve assembly 20 at an input port 22. An outlet port 24 terminates in a nozzle 26. Nozzle 26 may be interchanged to accommodate the particular fluid being dispensed, or to vary the rate or other dispensing characteristic. The inner diameters of ports 22 and 24 may be threaded to receive fittings used to connect inlet port 22 to conduit 16, and outlet port 24 to nozzle 26.

FIG. 2 shows an enlarged perspective view of a portion of FIG. 1, including valve assembly 20. As discussed, valve assembly 20 is connected at inlet port 22 to distal end 18 of conduit 16.

In operation, valve assembly 20 is held in the hand of an operator, and fluid (such as adhesive) is dispensed from nozzle 26 by depressing lever 34. The ball-shaped valve body (described in additional detail below) is ergonomically suited for holding in the hand of the user. Lever 34 may be depressed by, for example, the user's index finger, while the tip of nozzle 26 is moved along the site at which fluid is to be dispensed. In addition to the ergonomic design, valve assembly 26 is advantageously designed to simplify manufacture, assembly and operation. As will be described below, the valve assembly comprises a relatively small number of parts.

FIG. 3 shows a plan view of valve assembly 20. Visible in FIG. 3 is ball-shaped valve body 36, retainer 38, lever 34 and collar 40. Also shown in FIG. 3 is outlet port 24 and internal bore 48.

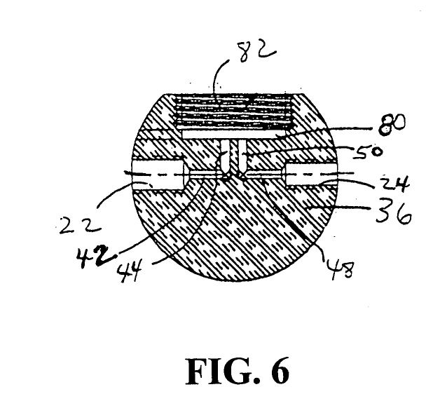

FIG. 4 shows a cross-sectional view of valve assembly 20 taken through line 4-4 of FIG. 3. Visible in FIG. 4 are ball-shaped body 36 and opposed inlet and outlet ports 22 and 24. At the base of inlet port 22 is a bore 42 which extends toward, but does not reach, the center of body 36. A second bore 44 intersects bore 42 at a substantially right angle. Bore 44 extends from the intersection with bore 42 to a surface 46 of a countersink in body 36. Surface 46 is more clearly illustrated in FIGS. 5 and 6, described below.

Extending from the bottom of outlet port 24 is a bore 48. Bore 48 extends toward, but does not reach, the center of body 36. In the embodiment illustrated, bore 48 extends toward and is substantially coaxial with bore 42. However, bore 48 does not intersect bore 42. Rather, bore 48 intersects bore 50 at a substantially right angle. Bore 50 extends from its intersection with bore 48 to surface 46, and lies substantially parallel to bore 44. As will be described in more detail below, inlet port 22, bore 42, bore 44, bore 50, bore 48 and outlet port 24 form a flow path through body 36 for the fluid being dispensed.

Also visible in FIG. 4 is valve stem 52. Valve stem 52 is preferably made from a wear resistant material, such as Teflon®. In the illustrated embodiment, valve stem 52 is a one-piece structure which comprises a longitudinally-extending portion 54 and an integrally-formed, horizontally-extending disk-like portion 56. A circumferential groove 58 in the shape of an inverted “v” is formed in the bottom surface of disk-like portion 56. The outer periphery 60 of disk-like portion 56 is held fast in the countersink against surface 46 of valve body 36 by retainer 38. As will be discussed in additional detail below, that part of disk-like portion 56 which lies within groove 58 covers the respective ends of bores 44 and 50, and is selectively movable to block and unblock the ends of the bores to allow for selective flow of the fluid through the flow path formed in body 36. This is accomplished by removing enough material to form groove 58 to allow the longitudinal portion 54 and that part of disk-like portion 56 which lies inside groove 58 to move along the longitudinal axis of portion 54 in response to a force exerted in the direction of arrow 62 upon lever 34.

Retainer 38 engages threads formed in body 36 and, as discussed above, securely holds outer periphery 60 of portion 56 of valve stem 52 within the countersink. A silicon seal 64 is provided to allow for relative motion between valve body 36, valve stem 52, and retainer 38, while preventing the flow of fluid past these structures. In addition to outer periphery 60, retainer 38 retains spring 66 in position around portion 54 of valve stem 52. Spring 66 exerts a force against that part of disk-like portion 56 which lies within the circumference of groove 58. The force exerted by spring 66 tends to urge that part of disk-like portion 56 against the respective ends of bores 44 and 50 so as to close the flow path extending through body 36. The force exerted on lever 34 in the direction of arrow 62 creates a force on valve stem 52 which opposes the force of the spring, and thus tends to open the flow path through body 36. When the force on the lever is removed, the force generated by spring 66 serves to close the flow path.

A boss or shoulder 68 is formed on retainer 38. An end 70 of lever 34 is provided with an opening through which valve stem 52 extends. End 70 of lever 34 is positioned adjacent boss 68. A collar 72 is positioned adjacent end 70 of lever 34, and is secured to valve stem 52 by, for example, a split pin 74. When a force is exerted on the lever in direction of arrow 62, boss 68 acts as a fulcrum and longitudinal portion 54 of valve stem 52 is moved axially away from the center of valve body 36. This causes that part of disk-like portion 56 which lies within the circumference of groove 58 to move away from the respective ends of bores 44 and 50, thus allowing the flow of fluid through body 36. When the force on the lever is removed, spring 66 exerts a force on that part of disk-like portion 56 so as to close the flow path.

In addition to seal 64, a silicon seal 76 is provided between retainer 38 and portion 54 of valve stem 52 to serve as a safety seal to prevent fluid flow past the valve stem and into the user's hand in the event of a rupture of disk-like portion 56 of valve stem 52.

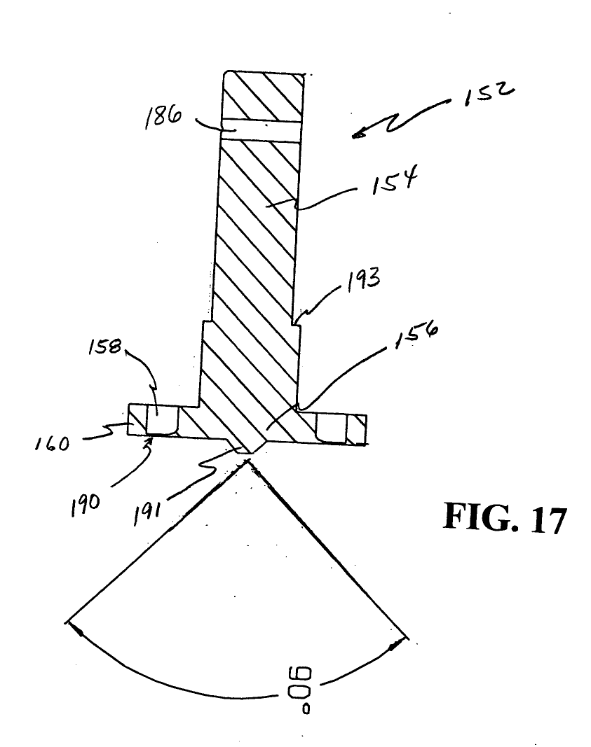

FIG. 5 shows a perspective view of ball-shaped valve body 36. Visible in FIG. 5 is outlet port 24 and a relatively shallow bore 78 which extends radially inwardly toward the center of body 36. Countersink 80 is shown at the bottom of bore 78. Surface 46 is also visible in FIG. 5, as is a portion of the end of bore 44 which extends through surface 46. An inner diameter of bore 78 is provided with female threads 82 which receive and mate with male threads 84 (see FIG. 17) of retainer 38. At least the central portion of surface 46 in the immediate area of bores 44 and 50 is polished smooth so as to provide a relatively good sealing surface adjacent the “face” of that part of disk-like portion 56 of valve stem 52 which lies within circumferential groove 58.

FIG. 6 shows a cross-sectional view of valve body 36. In one embodiment, the diameter of ball-shaped valve body 36 is approximately 1.5 inches, the diameter of countersink 80 is approximately 0.75 inch, and the depth of countersink 80 (as measured from the bottom of threads 82) is approximately 0.063 inch. In one embodiment, valve body 36 is formed of plastic, such as DELRIN™.

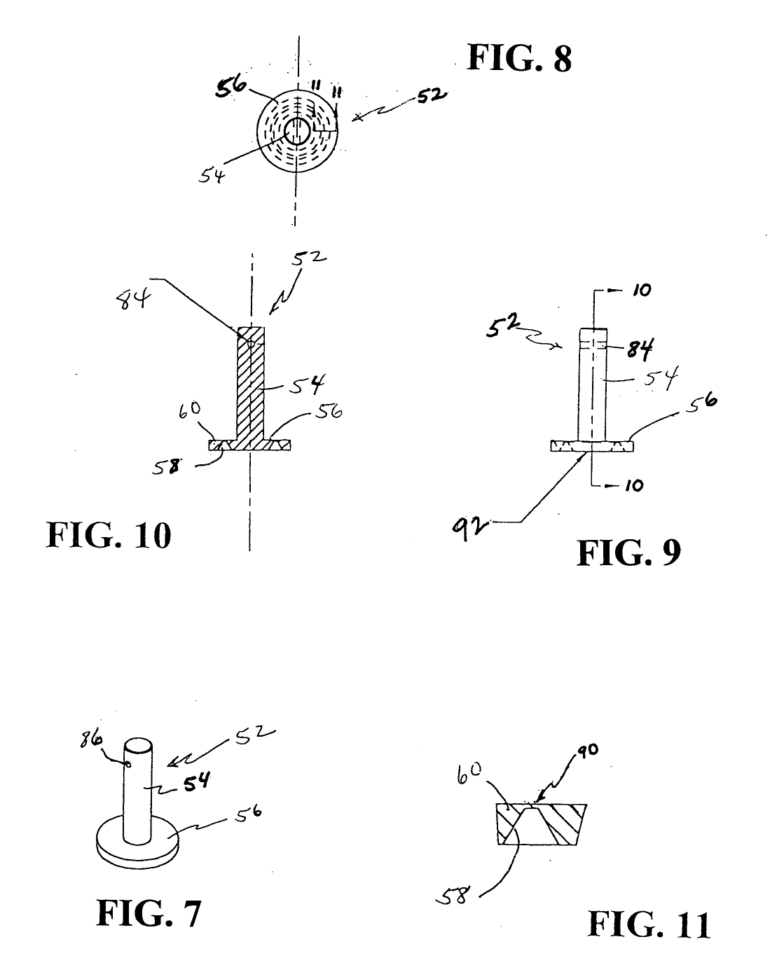

FIG. 7 shows a perspective view of valve stem 52. Visible in FIG. 7 is longitudinal portion 54 and disk-like portion 56. Groove 58, discussed above in connection with FIG. 4, is formed in the outwardly facing surface of portion 56 and is not visible in FIG. 7. Groove 58 is discussed in additional detail in connection with FIGS. 8-11 below. Visible in FIG. 7 is one end of a transverse bore 86 which receives split pin 74 to secure collar 72, as described above.

FIG. 8 shows a top plan view of valve stem 52. FIG. 9 shows a side plan view of valve stem 52. FIG. 10 shows a sectional view taken along line 10-10 of FIG. 9. Bore 54 and circumferential groove 58 are both visible in the cross-sectional view of FIG. 10. Reference numeral 60 denotes the outer periphery of portion 56 which comprises the part of disk-like portion 56 which lies outside the circumference of groove 58.

FIG. 11 shows a partial cross-sectional view through groove 58. As discussed above, groove 58 has the shape of an inverted “v” with a truncated “peak.” In the vicinity of the truncated “v” an area of reduced thickness is formed. This area is indicated in FIG. 11 by reference numeral 90. In one embodiment, the thickness of disk-like portion 56 of valve stem 52 is approximately 0.094 inch, and the depth of inverted v-shaped groove 58 is approximately 0.084 inch. Thus, the thickness of the area indicated by reference numeral 90 is approximately 0.010 inch. The width of the groove at the top of the truncated peak is approximately 0.030 inch. The side walls of the groove form an angle of approximately 60 degrees with one another (approximately 30 degrees with a vertical line drawn through the center of the groove, as viewed in FIG. 11). The outward “face” 92 of the disk-like portion 56 defined by the circumferential groove is polished smooth so as to seat securely on that portion of surface 46 of body 36 which surrounds the respective ends of bores 44 and 50. The area of reduced thickness indicated by reference numeral 90 allows face 52 to be lifted from contact with surface 46 (while outer periphery 60 is held in place by retainer 38) so as to open a flow path between the respective ends of bores 44 and 50, as previously described. As also previously noted, valve stem 52 is preferably made from an abrasion-resistant material, such as Teflon®.

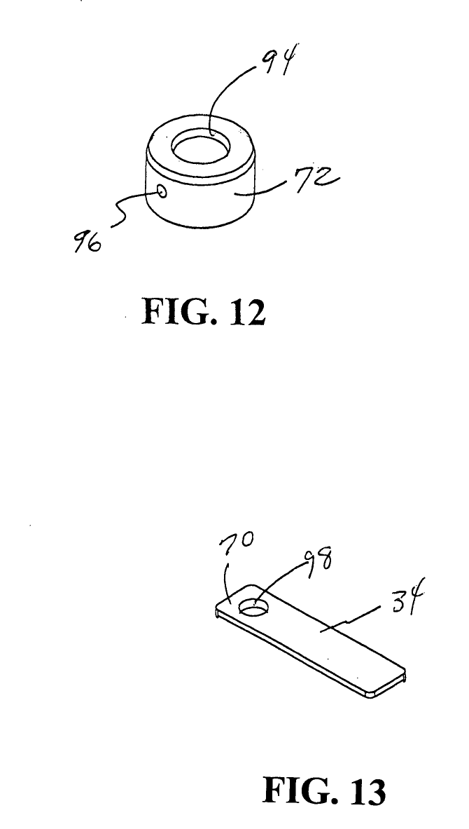

FIG. 12 shows a perspective view of collar 72. Visible in FIG. 12 is a relatively large central opening 94, through which an end of valve stem 52 extends, and one end of a relatively smaller transverse bore 96 which receives split pin 74 to secure valve stem 52 and collar 72 together. In one embodiment, collar 72 is formed of aluminum with a black oxide finish.

FIG. 13 shows a perspective view of lever 34. Visible in FIG. 13 is an opening 98 formed in end 70 of lever 34. Opening 98 receives longitudinal portion 54 of valve stem 52. In one embodiment, lever 34 is made of aluminum with a black oxide finish.

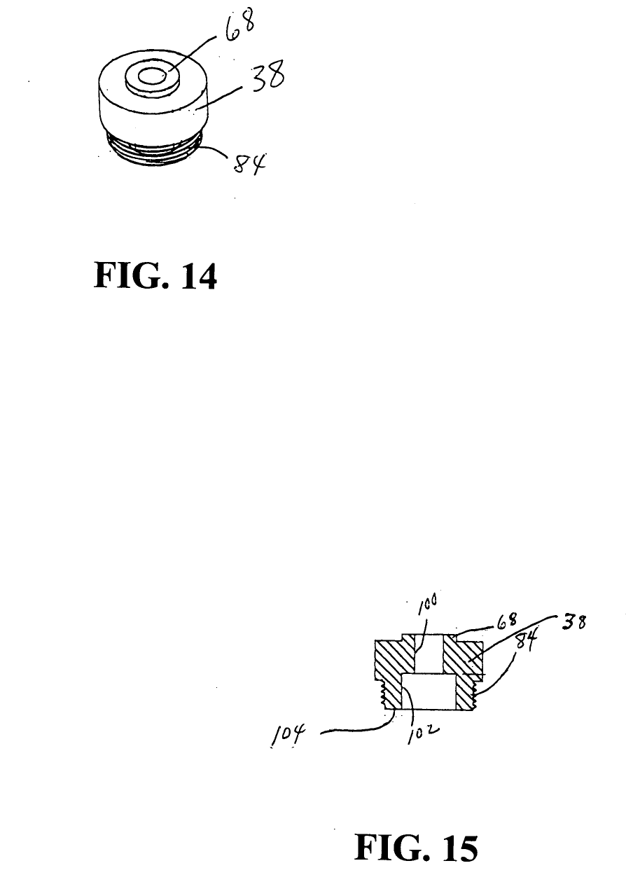

FIG. 14 is a perspective view of retainer 38. Visible in FIG. 14 are male threads 84 which engage female threads 82 in body 36 to secure retainer 38 to body 36. Also visible in FIG. 14 is boss 68 which serves as a fulcrum for lever 34, as previously described.

FIG. 15 shows a cross-sectional view of retainer 38. Retainer 38 has a bore 100 which receives longitudinal portion 54 of valve stem 52. A larger diameter counter bore 102 extends coaxially with bore 100. Counter bore 102 creates space for spring 66, which surrounds that part of longitudinal portion 54 of valve stem 52 which lies immediately adjacent disk-like portion 56. An outwardly-facing, circumferentially extending surface 104 of retainer 38 is dimensioned so as to secure that part of disk-like portion 56 of valve stem 52 which lies outside the circumference of groove 58 (indicated by reference numeral 60 in FIGS. 4, 10 and 11) firmly in position within countersink 80 of valve body 36.

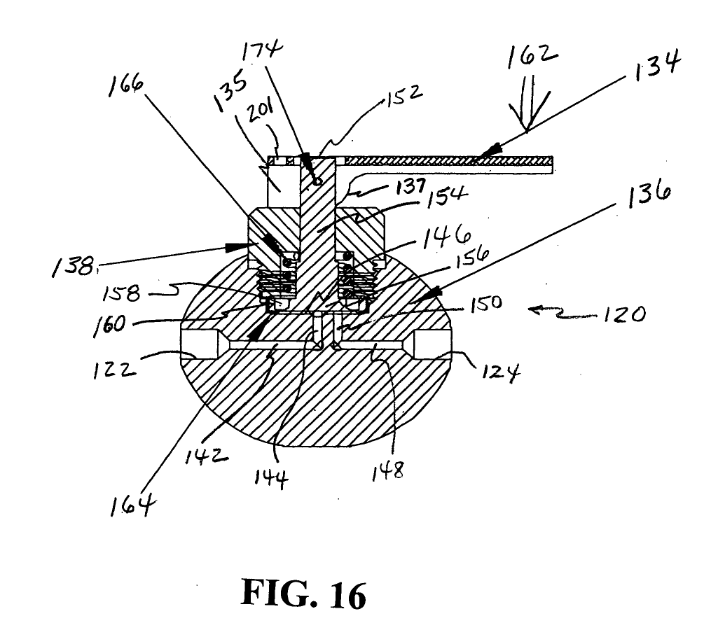

FIGS. 16-23 show valve assembly 120, and individual component parts thereof, which is an alternative embodiment which may be used in place of valve assembly 20. While several of the components differ from the above-described embodiment (as discussed below), to the extent possible corresponding parts of valve assembly 120 will be identified by the same reference numerals used in connection with valve assembly 20 above, increased by “100.” That is, valve assembly 20 corresponds to valve assembly 120, lever 34 corresponds to lever 134, valve body 36 corresponds to valve body 136, and so on.

FIG. 16 shows a cross-sectional view of valve assembly 120. This view corresponds to the cross-sectional view of valve assembly 20 shown in FIG. 4. Visible in FIG. 16 are body 136 and opposed inlet and outlet ports 122 and 124. At the base of inlet port 122 is a bore 142 which extends toward and to the approximate center of body 136. A second bore 144 intersects bore 142 at a substantially right angle. Bore 144 extends from the intersection with bore 142 to a surface 146 of a countersink in body 136. Surface 146 is also pictured in FIG. 23 below.

Extending from the bottom of outlet port 124 is a bore 148. Bore 148 extends toward, but does not reach, the center of body 136. In the embodiment illustrated, bore 148 extends toward and is substantially coaxial with bore 142. However, bore 148 does not intersect bore 142. Rather, bore 148 intersects bore 150 at a substantially right angle. Bore 150 extends from its intersection with bore 148 to surface 146, and lies substantially parallel to bore 144. As will be described in more detail below, inlet port 122, bore 142, bore 144, bore 150, bore 148 and outlet port 124 form a flow path through body 36 for the fluid being dispensed.

Also visible in FIG. 16 is valve stem 152. Valve stem 152 is preferably made from a wear resistant material, such as Teflon®. In the illustrated embodiment, valve stem 152 is a one-piece structure which comprises a longitudinally-extending portion 154 and an integrally-formed, horizontally-extending disk-like portion 156. A circumferential groove 158 is formed in the “top” surface of disk-like portion 156. An outer periphery 160 of disk-like portion 156 is held fast in the countersink against surface 146 of valve body 136 by retainer 138. As was the case with the embodiment of valve assembly 20 discussed above, that part of the disk-like portion 156 which lies within groove 158 extends over the respective ends of bores 144 and 150, and is selectively movable to block and unblock the ends of the bores to allow for selective flow of the fluid through the fluid flow path formed in body 136. The exact manner in which the face of disk-like portion 156 interacts with bores 144 and 150, however, differs from that described above in connection with the alternate embodiment. These differences are described in greater detail below.

As was the case with the embodiment described above, the purpose of groove 158 in the embodiment of FIG. 16 is to allow the longitudinal portion 154 in that part of disk-like portion 156 which lies inside groove 158 to move along the longitudinal axis of portion 154 in response to a force exerted in the direction of arrow 162 upon lever 134. However, unlike the previously described embodiment, groove 158 has a “u-shape,” rather than a “v-shape,” and is formed in the top surface of disk-like portion 156, rather than in the bottom surface. These differences are illustrated in greater detail in FIG. 17.

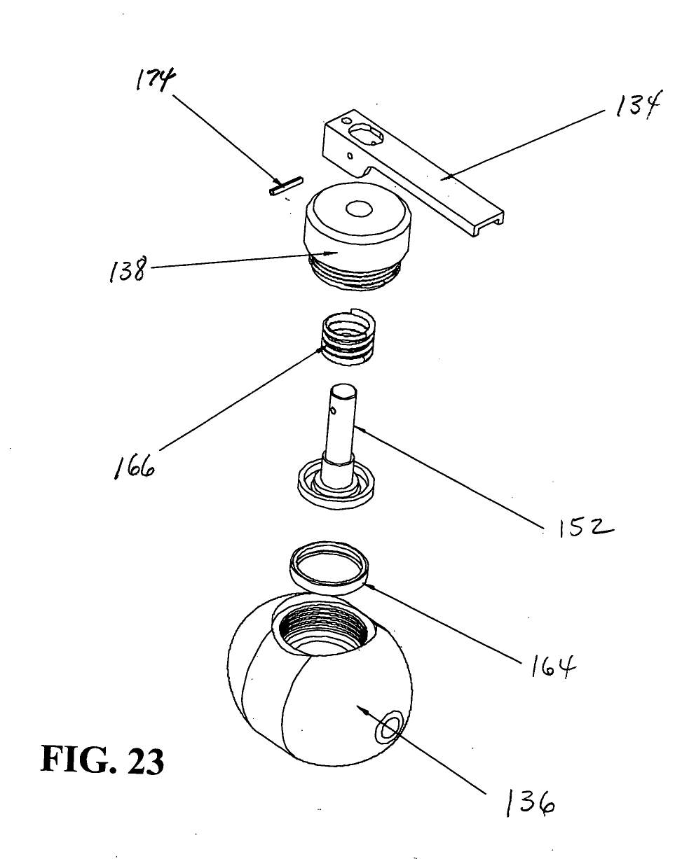

Referring again to FIG. 16, retainer 138 engages threads formed in body 136 and, as discussed above, and in connection with valve assembly 20, securely holds outer periphery 160 of disk-like portion 156 of valve stem 152 within the countersink. An alternative seal 164 is disposed between outer periphery 160 of disk-like portion 156 and surface 146. Seal 164 is shown in detail in FIGS. 21 and 22 below. As is the case with silicon seal 64 of valve assembly 20, the purpose of seal 164 is to prevent the flow of fluid between outer periphery 160 and valve body 136.

In addition to outer periphery 160, retainer 138 retains spring 166 in position around portion 154 of valve stem 152. Spring 166 exerts a force against that part of disk-like portion 156 which lies within the circumference of groove 158. The force exerted by spring 166 tends to urge that part of disk-like portion 156 toward surface 146 and the respective ends of bores 144 and 150. The force exerted on lever 134 in the direction of arrow 162 creates a force on valve stem 152 which opposes the force of the spring, and thus tends to open the flow path through body 136. When the force on the lever is removed, the force generated by spring 166 serves to close the flow path.

One difference between the embodiment of FIG. 16 and that of FIG. 4 is the design of the top-most surface of retainer 138, and the adjacent portion of lever 134. Retainer 38 of valve assembly 20 has a boss or shoulder 68 formed thereon. Boss 68 acts as a fulcrum for lever 34, as discussed above. In the embodiment of FIG. 16, the top surface of retainer 138 is relatively flat and is not provided with a shoulder or boss. Rather, lever 134 has a portion 135 which extends downwardly from the longest horizontal (as oriented in FIG. 16) axis of lever 134. A “leading edge” 137 of portion 135 is arcuately shaped to form a camming surface which serves as a fulcrum when lever 134 is acted upon by a force in the direction of arrow 162. As is the case with valve assembly 20, lever 134 is coupled to valve stem 152 by a split pin 174. The pivotal nature of the connection between valve stem 152 and lever 134 by split pin 174 causes valve stem 152 to move longitudinally and upwardly (as shown in FIG. 16) when the force acts on lever 134 in accordance with arrow 162.

Two differences between body 136 of valve assembly 120 and valve body 36 of valve assembly 20 should be noted. First, body 136 is still generally ball-shaped, but is slightly elongated so as to have more of an oval cross section. The reasons for this change are ergonomic. Second, bore 142 extends to approximately the center of valve body 136, and bore 144 extends into the approximate center of surface 146. The purpose of this change relates to the manner in which valve stem 152 interacts with bore 144 to block fluid flow through the flow path. The manner of interaction is discussed in additional detail in connection with FIG. 17.

FIG. 17 shows an isolated cross-sectional view of valve stem 152. Visible in FIG. 17 is longitudinal portion 154 and disk-like portion 156. Groove 158, as discussed above in connection with FIG. 16, is formed on the opposite surface (as compared to valve stem 52) of disk-like portion 156, and opens upwardly as valve stem 152 is oriented in FIGS. 16 and 17. Groove 158 forms an area of reduced thickness, generally indicated by reference numeral 190, which allows the central portion of valve stem 152 to move longitudinally, while outer periphery 160 remains fixed relative to body 136. Valve stem 152 is provided with a downwardly-extending, cone-shaped projection 191 located in the approximate center of disk-like portion 156. Cone-shaped projection 191 is truncated, with the diameter at its truncated distal end being smaller than the diameter of bore 144 in valve body 136. Projection 191 extends into the open end of bore 144 to block bore 144 and, thus, the flow path through valve body 136. When a force acts on lever 134 in the direction of arrow 162, the movable portion of valve stem 152 moves longitudinally away from bore 144, causing projection 191 to be withdrawn from bore 144, thus unblocking the flow path.

An additional feature of valve stem 152 is shoulder 193. Shoulder 193 interacts with an adjacent surface of retainer 138 to limit the extent of movement of valve stem 152. Also visible in FIG. 17 is transverse bore 186 which receives split end 174.

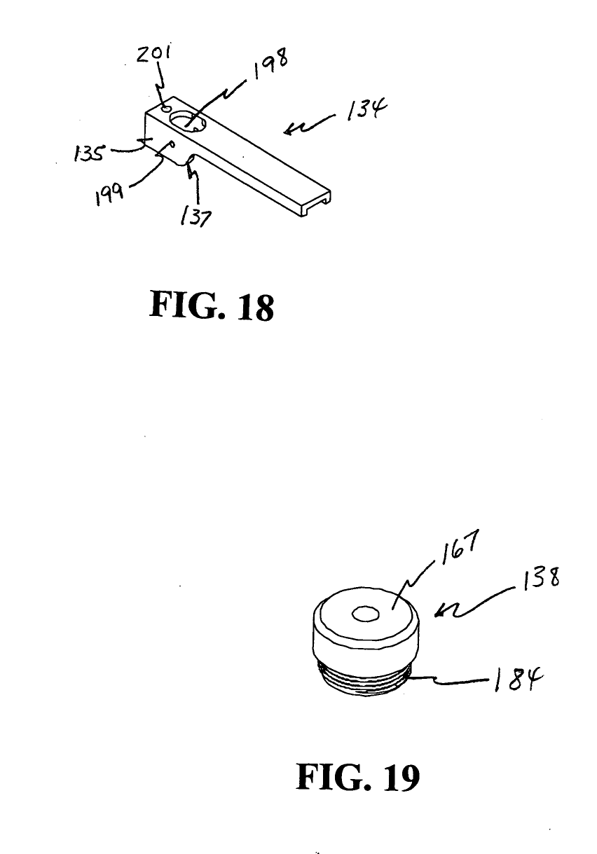

FIG. 18 shows an isolated perspective view of lever 134. Lever 134 has a generally u-shaped cross section which is more pronounced in the vicinity of portion 135, as discussed above. As also discussed above, the downwardly extending “legs” of the “u” are arcuately shaped in the vicinity of reference numeral 137 to provide a camming surface which serves as a fulcrum for moving valve stem 152.

Also visible in FIG. 18 is a central opening 198 which provides clearance for valve stem 152. A bore 199 in the downwardly extending “leg” of portion 135 is provided to accept rolled pin 174. A corresponding bore is provided in the opposing leg of lever 134. Finally, a hole 201 is provided in lever 134. Hole 201 allows valve assembly 120 to be suspended from a hook when not in use. A similar feature may be added to valve assembly 20.

FIG. 19 shows an isolated, perspective view of retainer 138. Visible in FIG. 19 is the top surface 167 of retainer 138 which, as discussed above, is relatively flat and lacks the shoulder or boss feature of retainer 38 of valve assembly 20. Also visible in FIG. 19 are external threads 184 which engage corresponding female threads in body 136 to secure retainer 138 to body 136.

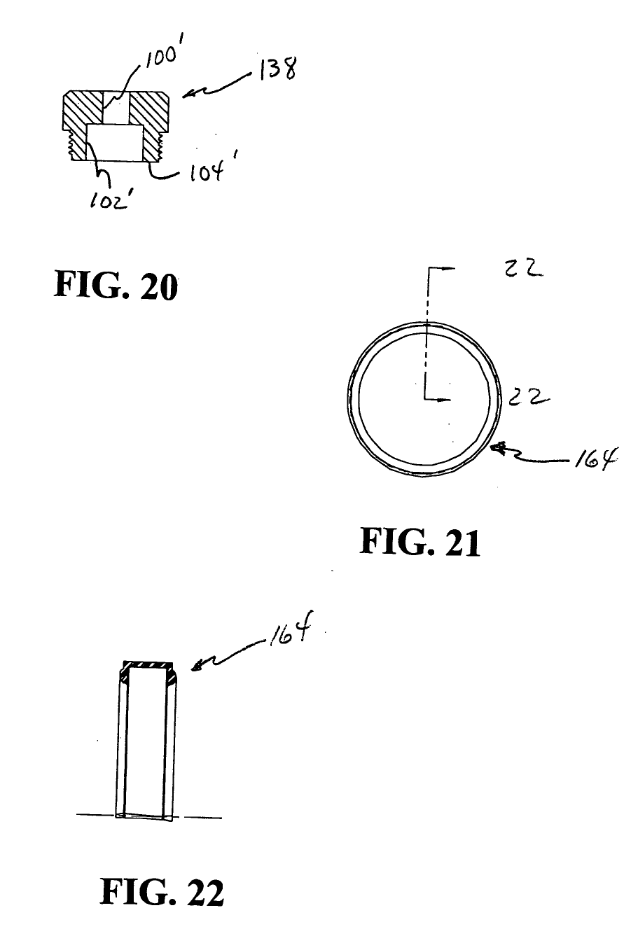

FIG. 20 shows a cross-sectional view of retainer 138. Retainer 138 has a bore 100′ which receives longitudinal portion 154 of valve stem 152. A larger diameter counter bore 102′ extends coaxially with bore 100′. Counter bore 102′ creates space for spring 166. Surface 104′ of retainer 138 is dimensioned so as to secure outer periphery 160 of valve stem 152 in a fixed position relative to valve body 136. Further, the portion of surface 104′ immediately surrounding counter bore 102′ is the portion of retainer 138 which interacts with shoulder 193 of valve stem 152 to provide for a positive stop to the motion of valve stem 152.

FIG. 21 shows a plan view of seal 164. FIG. 22 shows a partial cross section of seal 164 taken along line 22-22 of FIG. 21. Seal 164 is formed of a single piece, and replaces the multiple seal elements of the embodiment illustrated by valve assembly 20. Finally, FIG. 23 shows an exploded view of valve assembly 120. Visible in FIG. 23 are valve body 136, seal 164, valve stem 152, spring 166, retainer 138, lever 134 and rolled pin 174.

Although the above description refers to particular means, materials and embodiments, one skilled in the art can easily ascertain the essential characteristics of the present invention. Various changes and modifications may be made to adapt to various uses and characteristics without departing from the spirit and scope of the present invention as set forth in the following claims.

What is claimed is:

1. Fluid dispensing apparatus, comprising:
a reservoir containing a quantity of fluid, said reservoir having an outlet;
a conduit having a proximal end connected to the outlet of the reservoir, and having a distal end; and
a valve assembly, said valve assembly comprising:
a valve body, said body having an inlet and an outlet, and a fluid flow path extending from said inlet to said outlet, said inlet being connected to the distal end of the conduit;
a valve element having a first portion fixedly retained relative to said valve body, and having a second portion movably retained relative to said valve body, said second portion acting to selectively block and unblock the fluid flow path, and
an actuator, coupled to the second portion of the valve element, for transmitting an applied force to the valve element to cause the second portion of the valve element to move relative to the valve body.

2. The dispensing apparatus of claim 1, wherein at least a portion of said valve body is spherically shaped.

3. The dispensing apparatus of claim 2, wherein said valve body has a generally-circular cross section.

4. The dispensing apparatus of claim 2, wherein said valve body has a generally oval-shaped cross section.

5. The dispensing apparatus of claim 1, wherein said valve body further comprises a surface formed internally of the valve body, and wherein said fluid flow path comprises a first bore extending from the inlet to said surface, and a second bore extending from the outlet to said surface.

6. The dispensing apparatus of claim 4, wherein said second portion of said valve element is disposed adjacent said internal surface so as to selectively block and unblock at least one of said first and second bores.

7. The dispensing apparatus of claim 6, wherein said valve element includes a projection which extends into one of said first and second bores so as to block the fluid flow path when the valve element is in a first position, and which is withdrawn from said bore when the valve element is moved to a second position.

8. The dispensing apparatus of claim 7, wherein said projection extends from an approximate center of the second portion of the valve element and wherein at least one of the first and second bores extends into an approximate center of the internally-formed surface.

9. The dispensing apparatus of claim 1, wherein said valve body is formed from a single piece of material.

10. The dispensing apparatus of claim 1, wherein said valve body is formed of plastic, such as DELRIN™.

11. The dispensing apparatus of claim 1, further comprising a nozzle coupled to the outlet of the valve body.

12. The dispensing apparatus of claim 11, further comprising a plurality of interchangeable nozzles of varying sizes to regulate fluid flow through the outlet.

13. The dispensing apparatus of claim 1, further comprising a retainer coupled to the valve body for retaining the valve element in position relative to the valve body.

14. The dispensing apparatus of claim 13, wherein said retainer comprises a surface which fixes the first portion of the valve element relative to the valve body.

15. The dispensing apparatus of claim 13, wherein said valve body has a threaded bore formed therein, and wherein said retainer is secured within said threaded bore.

16. The dispensing apparatus of claim 1, further comprising a spring disposed around the second portion of the valve element to bias said second portion toward a position which blocks the fluid flow path.

17. The dispensing apparatus of claim 16, further comprising a retainer coupled to the valve body, said retainer retaining said spring in position around the second portion of the valve element.

18. The dispensing apparatus of claim 1, wherein said valve element comprises a disk-like portion having a groove formed in a surface thereof.

19. The dispensing apparatus of claim 18, wherein said groove forms an area of reduced thickness in said disk-like portion, and wherein said first fixedly-retained portion of the valve element comprises an annular portion defined, at least in part, by said groove, and wherein said area of reduced thickness facilitates movement of said second movable portion.

20. The dispensing apparatus of claim 18, wherein said valve element further comprises an elongate portion extending outwardly from said disk-like portion.

21. The dispensing apparatus of claim 1, wherein said valve element is formed from a single piece of abrasion-resistant material, such as Teflon®.

22. The dispensing apparatus of claim 21, wherein said valve element includes a stop to limit movement of the second portion thereof.

23. The dispensing apparatus of claim 21, wherein said valve element comprises a disk-like portion and an elongate portion extending from a surface of said disk-like portion.

24. The dispensing apparatus of claim 23, wherein said valve element has a groove formed in a surface thereof, and wherein said groove creates an area of reduced thickness in said disk-like portion.

25. The dispensing apparatus of claim 24, wherein said area of reduced thickness is disposed between the first, fixedly-retained portion of the valve element and the second movable portion of the valve element, and facilitates movement of said second portion.

26. The dispensing apparatus of claim 1, wherein said actuator is a lever pivotally coupled to said valve element.

27. The dispensing apparatus of claim 26, wherein said lever includes a camming surface to serve as a fulcrum for transmitting the applied force to the valve element.

28. The dispensing apparatus of claim 27, wherein said lever is pivotally coupled to the second portion of the valve element, and further comprising a retainer coupled to the valve body for retaining the valve element in position relative to the valve body, and wherein said camming surface interacts with a surface of the retainer to cause the second portion of the valve element to move relative to the valve body.

29. The dispensing apparatus of claim 26, wherein said lever has at least one opening formed therein.

30. The dispensing apparatus of claim 1, further comprising a seal disposed between the first portion of the valve element and the valve body.
